(19) United States
(12) Patent Application Publication
(10) Pub. No.: US 2011/0139693 A1
(43) Pub. Date: Jun. 16, 2011

(54) CONVEYOR BELT FILTER DEVICE

(76) Inventor: Guido Frankenberger, Wetzlar (DE)

(21) Appl. No.: 12/967,293

(22) Filed: Dec. 14, 2010

(30) Foreign Application Priority Data
Dec. 15, 2009 (EP) 09179271.3

(51) Int. Cl. E02B 5/08; B01D 33/00

(52) U.S. Cl. 210/160

(57) ABSTRACT

The invention pertains to a conveyor belt filter device comprising: (a) an endless filter belt of flat, interconnected filter elements that can be respectively pivoted relative to one another about a horizontal link axis; (b) flexible driving means that are respectively provided to both sides of the filter belt and consist of a chain drive with deflection elements and two endless drive chains, on which the filter elements are laterally mounted; and (c) a framework that carries the deflection elements and the filter belt, wherein each filter element is rigidly mounted on a chain link and front surfaces of the filter element respectively feature an abutment edge that extends parallel to the link axes of the chain links, such that the opposite abutment edges define a filter gap formed between two filter elements, and wherein the filter gap is provided with a gap seal.

This application claims priority from European Patent Application No. 09179271.3 filed Dec. 15, 2009. The entire disclosure of the above patent application is hereby incorporated by reference.

### FIELD OF THE INVENTION

The present invention pertains to a conveyor belt filter device for mechanically cleaning a fluid that is polluted with solids and flows in a channel or the like, with

an endless filter belt of flat, interconnected filter elements that can be respectively pivoted relative to one another about a horizontal link axis and

flexible driving means that are respectively provided to both sides of the filter belt and consist, for example, of a chain drive with deflection elements and two endless drive chains, on which the filter elements are laterally mounted, as well as

a framework that carries the deflection elements and the filter belt, wherein each filter element is rigidly mounted on a chain link and front surfaces of the filter element respectively feature an abutment edge that extends parallel to the link axes of the chain links, namely such that the opposite abutment edges define a filter gap formed between two filter elements.

### BACKGROUND OF THE INVENTION

Conveyor belt filter devices of the initially cited type are also referred to as so-called “paternoster filter rakes” and primarily serve for mechanically cleaning waste water flowing in channels designed for this purpose. The waste water flows through the filter elements that remove the filtered matter unable to pass through the filter screens from the channel. Due to the design of the filter belt in the form of interconnected filter elements that are connected by means of flexible driving means mounted on both sides of the filter elements, the required relative movements between the filter elements in the deflection regions, in particular, make it necessary to provide a gap between the individual filter elements in order to realize these relative movements.

Successful developments known from the state of the art already make it possible to realize such a filter gap constant regardless of the actual relative positioning of the filter elements such that the filter gap can be maintained constant in the region of the straight transport sections of a revolving filter belt, as well as in the deflection segments that are provided with a curvature radius. A conveyor belt filter device of this type is known, for example, from EP 0 676 227 A1.

Although this already makes it possible to maintain a filter gap formed between two filter elements constant over the entire transport distance, it is possible, for example, that filter gaps between different filter elements are formed differently due to manufacturing tolerances of the chain and the filter bodies. Due to the inevitable elongation of the drive chain over the service life thereof, the filter gaps furthermore are regularly enlarged in a more or less continuous fashion such that the filter effect or the effectiveness of the conveyor belt filter device can deteriorate accordingly due to the increasing gap width, particularly toward the end of the service life of the driving means.

In addition, the advantageous development known from aforementioned EP 0 676 227 A1 already makes it possible to maintain an adjusted filter gap constant over the distance of the conveyor belt. As explained above, the realization of a filter gap is required for constructive reasons such that the filter gap in any case represents a discontinuity in the filter surface that otherwise has the uniform hole pattern arranged in the filter elements and an exact definition of the active filter surface is only possible to a limited degree.

### SUMMARY OF THE INVENTION

The present invention therefore is based on the objective of additionally developing a conveyor belt filter device in such a way that the above-described disadvantages resulting from the realization of a filter gap in a conveyor belt filter device are eliminated.

This objective is attained according to the invention with the characteristics of a conveyor belt filter device, characterized in that the conveyor belt filter device for mechanically cleaning a fluid (16) that is polluted with solids and flows in a channel (14) or the like, with an endless filter belt (11) of flat, interconnected filter elements (31) that can be respectively pivoted relative to one another about a horizontal link axis (52) and flexible driving means that are respectively provided to both sides of the filter belt and consist, for example, of a chain drive (12) with deflection elements and two endless drive chains (28), on which the filter elements are laterally mounted, as well as a framework (10) that carries the deflection elements and the filter belt, wherein each filter element is rigidly mounted on a chain link (30) and front surfaces (34, 35) of the filter element respectively feature an abutment edge (36) that extends parallel to the link axes of the chain links, namely such that the opposite abutment edges define a filter gap (41) formed between two filter elements, characterized in that the filter gap is provided with a gap seal (43, 60) that on one side of the filter belt features a sealing strip (43) that covers the filter gap and is supported on the filter elements with the sealing force and on the other side of the filter belt features a prestressing device (55, 65) that is connected to the sealing strip and serves for generating the sealing force. Additional, particular beneficial, embodiments of the invention are provided in accordance with the following subsidiary conveyor belt filter devices.

In accordance with a second conveyor belt filter device embodiment of the invention, the first embodiment is modified so that the sealing strip (43) is arranged on the inflow side of the filter belt (11) and the prestressing device (55, 65) is arranged on the outflow side of the filter belt. In accordance with a third conveyor belt filter device embodiment of the invention, the first embodiment and the second embodiment are further modified so that the front surfaces (34, 35) of the filter elements (31) form on the inflow side of the filter belt (11) a wedge-shaped filter gap (41) with gap flanks that are arranged relative to one another in an essentially V-shaped fashion and formed by the front surfaces, and in that the sealing strip adjoins the front surfaces in a sealing fashion with its longitudinal edges. In accordance with a fourth conveyor belt filter device embodiment of the invention, the first embodiment, the second embodiment and the third embodiment are further modified so that the longitudinal edges of the sealing strip (43) are formed by a convexly designed peripheral contour of the sealing strip. In accordance with a fifth conveyor belt filter device embodiment of the invention, the first embodiment, the second embodiment, the third embodiment and fourth embodiment are modified so that the sealing strip (43) has a circular cross section.

In accordance with a sixth conveyor belt filter device embodiment of the invention, the first embodiment, the second embodiment, the third embodiment, fourth embodiment and the fifth embodiment are modified so that the sealing strip has a hollow cross section. In accordance with a seventh conveyor belt filter device embodiment of the invention, the first embodiment, the second embodiment, the third embodiment, fourth embodiment, the fifth embodiment and the sixth embodiment are modified so that the sealing strip is provided with flow-through openings for the passage of the flowing fluid. In accordance with an eighth conveyor belt filter device embodiment of the invention, the seventh embodiment is modified so that the sealing strip is provided with a hole pattern such that the sealing strip acts as a filter element. In accordance with a ninth conveyor belt filter device embodiment of the invention, the first embodiment, the second embodiment, the third embodiment, fourth embodiment, the fifth embodiment, the sixth embodiment and the seventh embodiment are modified so that the sealing strip is composed of individual sealing elements that are arranged in a row.

In accordance with a tenth conveyor belt filter device embodiment of the invention, the first embodiment, the second embodiment, the third embodiment, fourth embodiment, the fifth embodiment, the sixth embodiment and the seventh embodiment, the eighth embodiment and the ninth embodiment are modified so that the prestressing device (55, 65) features a tension element (45, 61) that is connected to the sealing strip (43) with one end and extends through the filter gap (41) in the flow direction, wherein the other end of said tension element is connected to a pressure spring element (46) that is supported on a base that bridges the filter gap on the side of the filter belt that faces away from the sealing strip. In accordance with a eleventh conveyor belt filter device embodiment of the invention, the tenth embodiment is modified so that the pressure spring consists of a dimensionally elastic plastic element. In accordance with a twelfth conveyor belt filter device embodiment of the invention, the eleventh embodiment is modified so that the plastic element is realized in a tubular or sleeve-shaped fashion. In accordance with a thirteenth conveyor belt filter device embodiment of the invention, the first embodiment, the second embodiment, the third embodiment, fourth embodiment, the fifth embodiment, the sixth embodiment and the seventh embodiment, the eighth embodiment, the ninth embodiment, the tenth embodiment, the eleventh embodiment and the twelfth embodiment are modified so that the prestressing device (55, 65) is arranged centrally referred to the width of the filter gap (41).

According to the invention, generally, a filter gap is respectively realized in the conveyor belt filter device between two adjacent filter elements, wherein said filter gap is provided with a gap seal featuring a sealing strip that covers the filter gap and is supported on the filter elements with the sealing force on one side of the filter belt. A prestressing device connected to the sealing strip is provided on the other side of the filter belt in order to generate the sealing force.

Due to the inventive design of the conveyor belt filter device with a gap seal, the filter gap is effectively sealed without impairing the function of the conveyor belt filter device that requires an unobstructed movement of the filter elements over the transport distance. Since the sealing strip is prestressed against the filter element in a sealing fashion, relative movements are not only possible between the individual filter elements, but also between the sealing strip and the adjacent filter elements. In this case, the prestressing device neither impairs these relative movements nor the sealing effect of the sealing strip because it is situated on the opposite side of the filter belt referred to the sealing strip.

The sealing strip arranged in accordance with the invention therefore makes it possible to seal a filter gap regardless of its actual width, as well as regardless of the fact whether this filter gap changes during a revolution of the conveyor belt or over the service life of the conveyor belt filter device and its driving means, respectively. A filter gap consequently can be regularly inhibited or sealed such that the effective filter surface actually is defined by the hole pattern of the individual filter elements only.

In one preferred embodiment, the sealing strip is arranged on the inflow side of the filter belt and the prestressing device is arranged on the outflow side of the filter belt in order to ensure that the fluid flowing against the sealing strip contributes to an increase in the sealing force.

It is particularly advantageous if the front surfaces of the filter elements form a wedge-shaped filter gap on the inflow side of the filter belt, wherein the gap flanks formed by the front surfaces are essentially arranged relative to one another in a V-shaped fashion, and wherein the sealing strip adjoins the front surfaces in a sealing fashion with its longitudinal edges. Due to the V-shaped arrangement of the gap flanks, it is ensured that the normal force component that acts upon the gap flanks and is decisive for the generation of a sealing force is not only realized in the deflection regions of the conveyor belt, but also in the straight transport sections.

An additional increase of the sealing effect regardless of the position of the sealing strip relative to the front surfaces can be achieved, particularly with gap flanks that are formed by the front surfaces, if the longitudinal edges of the sealing strip are formed by a convexly designed peripheral contour of the sealing strip. If the sealing strip consists of a flat bar, this can already be realized by simply rounding off the longitudinal edges of the flat bar.

In this context, it is particularly advantageous if the sealing strip has a circular cross section. It would naturally also be possible to consider different cross-sectional shapes or such as, for example, a triangular cross section.

If the sealing strip has a hollow cross section, it is possible to limit the mass of the sealing strip to a required degree because only the type and design of the peripheral contour of the sealing strip are important for the sealing effect.

In order to prevent the filter gap from being completely sealed, if so required, the sealing strip may be provided with flow-through openings for the passage of the flowing fluid, wherein the sealing strip itself may also act as a supplementary filter element, particularly if the sealing strip is provided with a hole pattern. For example, the hole pattern can be realized in accordance with the hole pattern of the filter elements such that an undesirable filter gap is inhibited by the sealing strip on one side and the sealing strip contributes to an increase of an exactly defined filter surface on the other side.

In one preferred embodiment, the prestressing device features a tension element that is connected to the sealing strip with one end and extends through the filter gap in the flow direction, wherein the other end of said tension element is connected to a pressure spring element that is supported on a base that bridges the filter gap on the side of the filter belt that faces away from the sealing strip. In this way, a particularly advantageous prestressing device is realized that does not even impair gap changes occurring over the distance of the conveyor belt such that the risk of the prestressing device impairing the required relative movements between the filter elements can be largely precluded, namely even if the filter gaps change.

It is also particularly advantageous if the pressure spring element consists of a dimensionally elastic plastic element such that no components that are sensitive to corrosion need to be used for realizing the pressure spring.

If the plastic element is furthermore realized in a tubular or sleeve-shaped fashion, the desired effects with respect to the dimensional elasticity can be realized with particularly simple means.

It is also particularly advantageous if the prestressing device is arranged centrally referred to the width of the filter gap because a reliable function of the gap seal can be achieved in this fashion with only one prestressing device and the prestressing device furthermore does not impair the flow, particularly if the gap seal or the sealing strip is realized in the form of a supplementary filter element.

### BRIEF DESCRIPTION OF THE DRAWINGS

Preferred embodiments of the invention are described in greater detail below with reference to the drawings.

In these drawings:

FIG. 1 shows a side view of a conveyor belt filter device during its operation;

FIG. 2 shows two filter elements that are connected to one another on both sides by means of a drive chain, as well as their relative arrangement on a longitudinal transport section and a first embodiment of a gap seal;

FIG. 3 shows the filter elements illustrated in FIG. 2 viewed in the transport direction;

FIG. 4 shows a sectional representation of the filter elements illustrated in FIG. 3 along the line of section IV-IV;

FIG. 5 shows an enlarged detail of a filter gap formed between the filter elements illustrated in FIG. 4;

FIG. 6 shows the filter elements illustrated in FIG. 2 in a deflection region of the transport section;

FIG. 7 shows the filter elements illustrated in FIG. 6 viewed in the transport direction;

FIG. 8 shows a sectional representation of the filter elements illustrated in FIG. 7 along the line of section VIII-VIII;

FIG. 9 shows an enlarged detail of the filter gap formed between the filter elements in the deflection region;

FIG. 10 shows two filter elements that are connected to one another on both sides by means of a drive chain, as well as their relative arrangement on a longitudinal transport section and a second embodiment of a gap seal;

FIG. 11 shows the filter elements illustrated in FIG. 10 in a deflection region of the transport section, and

FIG. 12 shows a sectional representation of the gap seal illustrated in FIG. 10.

### DETAILED DESCRIPTION OF THE INVENTION

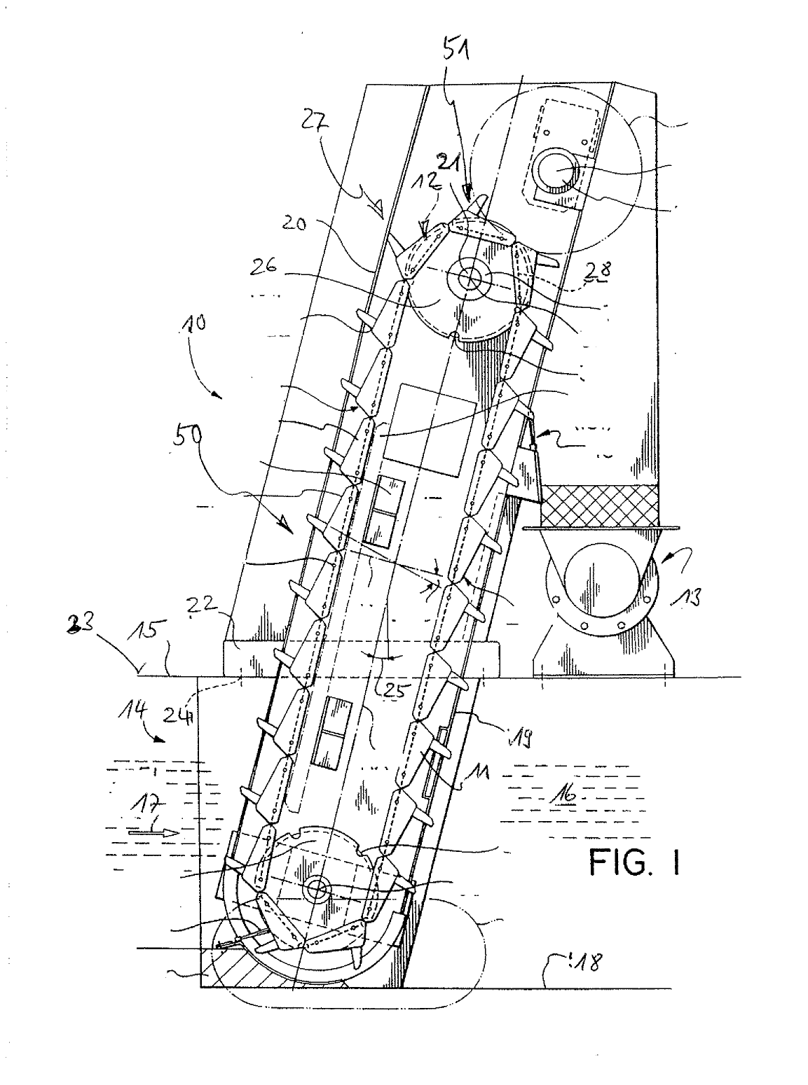

The conveyor belt filter device illustrated in FIG. 1 features a framework 10, a filter belt 11 that is guided on the framework 10, a chain drive 12 that is connected to the framework 10 and the filter belt 11 and an arrangement 13 for transporting away filtered matter that is designed for cleaning a channel 14 extending below ground level 15.

A fluid 16 polluted with solids flows through the channel 14 in a flow direction 17 that is indicated by a directional arrow, wherein the channel 14 may extend perpendicular to the plane of projection with a significant width. The conveyor belt filter device extends up to a channel bottom 18 such that the entire flow cross section of the channel 14 is blocked transverse to the flow direction 17 and the fluid 16 needs to pass through the part of the conveyor belt filter device situated in the channel 14.

Due to its arrangement in the channel 14 such that the filter belt 11 is directed transverse to the flow direction 17, the conveyor belt filter device illustrated in FIG. 1 is also referred to as a “flow-through filter belt rake.” However, the invention that is described below and defined in claim 1 may also be used in conveyor belt filter devices, in which the filter belt is directed parallel to the flow direction, wherein experts also refer to these conveyor belt filter devices as “central-flow” or “dual-flow” filter band rakes, in which the fluid flows through the filter belt transverse to the flow direction in the channel.

In the present embodiment, the framework 10 consists of a lower frame part 19 that forms the part to be passed by the fluid 16 and an upper frame part 20 that is situated outside the channel 14 and serves for mounting an electromotive drive that drives a shaft 21. A connecting frame 22 is provided between the frame parts 19 and 20 and makes it possible to stationarily lock the framework 10 to both sides of the channel 14, for example by means of screw-type anchors 24 embedded in the concrete sidewalls 23 of the channel 14.

The frame parts 19, 20 are connected to the connecting frame 22 in such a way that the framework 10 is inclined relative to the vertical line by an acute transport angle 25 when the ground level 15 extends about horizontally. In the exemplary embodiment shown, the transport angle amounts to approximately 15°, but may, in particular, also be larger. In contrast to the embodiment shown, the transport angle 25 does not have to be a fixed angle, but may also be variable, in which case the framework 10 is connected to the connecting frame 24 in a pivoted fashion.

The shaft 21 drives chain wheels 26 that are arranged to both sides of the filter belt 11 and respectively serve for driving a drive chain 28. The drive chains 28 are composed of chain links 30, wherein a synopsis of the illustrations in FIGS. 2 and 3 elucidates, in particular, that two respective chain links 30 of the drive chains 28 accommodate a filter element 31 between one another, namely such that the drive chains 28 form the filter belt 11 together with the filter elements 31.

The filter elements respectively feature a filter basket 40 that consists of a perforated sheet metal material in the present embodiment and features an inflow bottom 33 that is designed convexly toward the flow direction 17 and features front surfaces 34, 35 that are angled toward its edges in the transport direction and form an abutment edge 36. The filter baskets 40 feature sidewalls 37, 38 with a disk-shaped design in order to form a lateral boundary of the inflow bottom 33 and to connect the chain links 30.

FIGS. 2 and 3 furthermore show that a filter gap 41 is formed between the abutment edges 36 of two adjacent filter elements 31, wherein a gap seal 42 is arranged in said filter gap. The adjacent abutment edges 36 are arranged parallel and to both sides of the link axis 52, on which the chain links 30 and therefore the filter elements 31 are pivotally connected to one another by means of chain bolts.

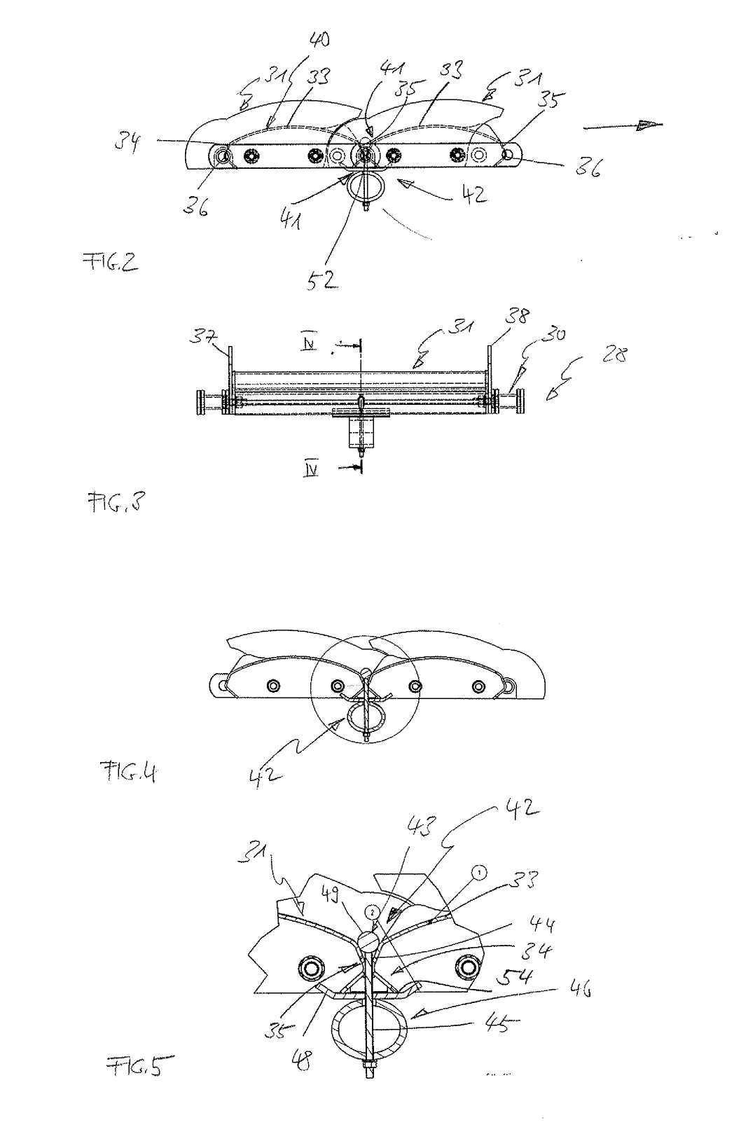

According to FIG. 4 and, in particular, the enlarged illustration of the gap seal 42 in FIG. 5, the gap seal features a sealing strip 43 that is manufactured of a round material in the exemplary embodiment shown and non-positively connected to a prestressing device 55. The prestressing device 55 features a tension element 45 that is realized in the form of a tie rod in this case and connected to the sealing strip by means of a connecting end 44. A pressure spring element 46 that is realized in the form of a dimensionally elastic plastic sleeve in this case is arranged on the tension element 45 and penetrated by the tension element 45 in such a way that the pressure spring element 46 is accommodated between a spring stop 47 that is formed by a nut screwed onto the free end of the tension element 45 in the present embodiment and a supporting stop that is arranged on the tension element 45 in a longitudinally displaceable fashion. The supporting stop 48 is realized in the form of a supporting sheet metal in the present embodiment and supported on supporting edges 54 formed by free ends of the respective front surfaces 35 and 34.

Due to the tensile force exerted upon the sealing strip 48 by the pressure spring element 46, the sealing strip 43 is pressed against the front surfaces 34, 35 of the adjacent filter elements 31 with its peripheral contour 49, wherein the front surfaces 34, 35 form a wedge-shaped receptacle for the sealing strip 43 due to their V-shaped arrangement relative to one another and define the narrowest point of the filter gap 41 in the flow direction 17.

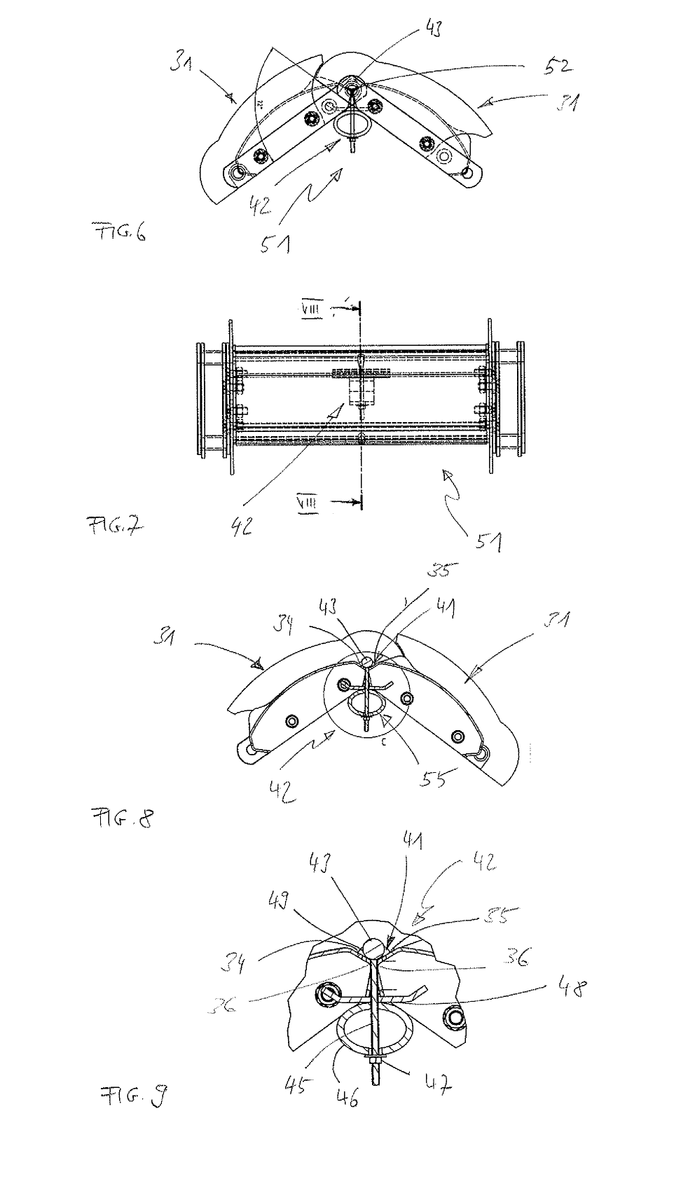

In contrast to FIGS. 2 to 5 that shows two adjacent filter elements 31 in a relative arrangement during the movement along a longitudinal transport section 50 (see FIG. 1) of the conveyor belt filter device, FIGS. 6 to 9 show the relative arrangement of two filter elements 31 in the deflection region 51 (see FIG. 1) of the conveyor belt filter device. In other respects, FIGS. 6 to 9 show the same elements and components of the conveyor belt filter device, wherein these elements and components in FIGS. 6 to 9 are identified by the same reference symbols as in FIGS. 2 to 5.

A comparison of FIGS. 4 and 5 that show the relative arrangement of the gap seal 42 in the filter gap 41 during a movement of the filter elements 31 along the longitudinal transport section 50 with FIGS. 8 and 9 that show the relative arrangement of the gap seal 42 in the filter gap 41 in the deflection region 51 elucidates, in particular, that the relative pivoting movement of the filter elements 31 about the link axis 52 (see FIG. 6) causes a shift in the position of the sealing strip 43 on the front surfaces 34, 35 of the adjacent filter elements 31. However, this comparison also elucidates that the contact of the peripheral contour 49 of the sealing strip 43 with the front surfaces 34, 35 is still ensured despite the changed relative positioning. The changed arrangement of the front surfaces 34, 35 relative to one another caused by the deflection merely leads to an increase in the tensile stress acting upon the sealing strip, namely as the result of a compression of the pressure spring element 46 that takes place between the spring stop 47 of the tension element 45 and the supporting stop 48.

In order to ensure that the tension element 45 is not clamped in the filter gap 41 in the relative arrangement of the front surfaces 34, 35 illustrated in FIG. 9, the front surfaces 34, 35 may be provided with corresponding recesses in the region of the abutment edges 36.

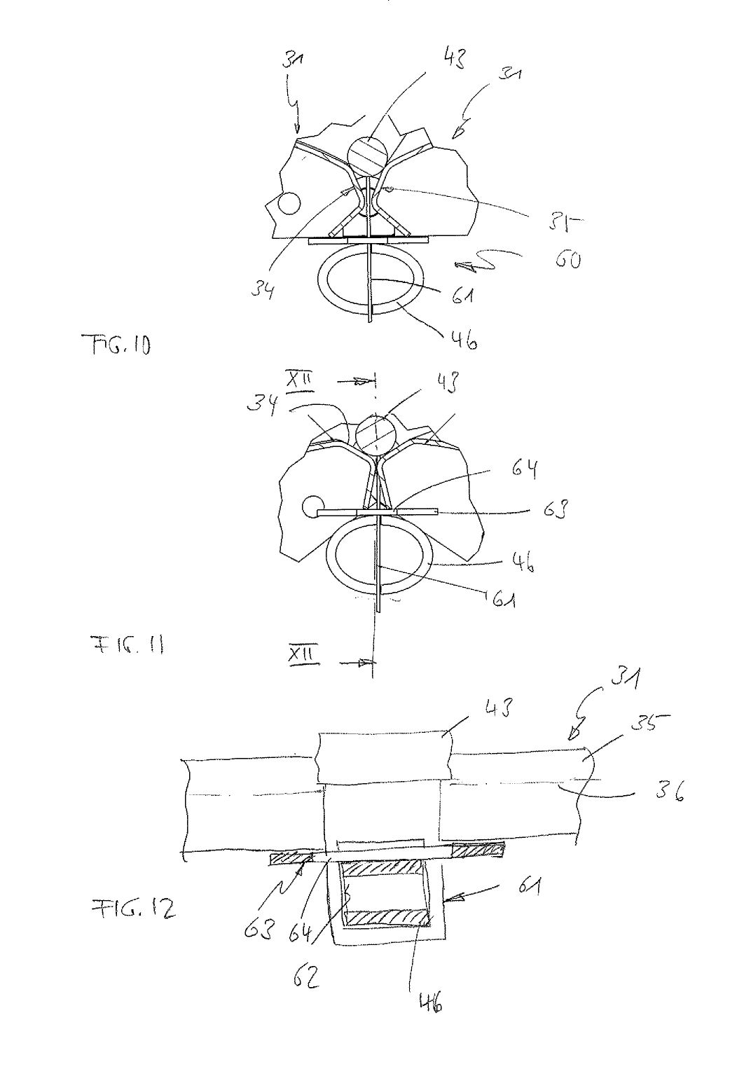

FIGS. 10 to 12 show another optional embodiment of a gap seal 60 that serves for sealing a filter gap 41 formed between the front surfaces 34, 35 of adjacent filter elements 31. In the present embodiment, the gap seal 60 features a sealing strip 43 that corresponds to the sealing strip 43 of the gap seal 42. In contrast to the gap seal 42, the gap seal 60 features a prestressing device 65 with a tension element 61 that, according to a synopsis of FIGS. 10 and 12, consists of a sheet metal strip with a rectangularly designed recess 62 for accommodating the sleeve-shaped pressure spring element 46. In order to non-positively position the pressure spring element 46 in the recess 62 of the tension element 61, a supporting stop 63 is provided that consists of a sheet metal strip in the present embodiment and features a correspondingly designed through-slot 64, through which the tension element 61 extends.

According to FIGS. 10 and 11 that show the relative positioning of the sealing strip 42 of the gap seal 60 between the front surfaces 34 and 35 of the adjacent filter elements 31 during the movement along a longitudinal transport section 50 (FIG. 10) and the aforementioned relative positioning during a movement in the deflection region 51 (FIG. 11), the pressure spring element 46 is supported during a compression on a supporting edge 65 of the recess 62 arranged in the tension element 61, as well as on the supporting stop 63 that can be longitudinally displaced relative to tension element 61.

The preceding explanation of the design of the gap seal 60 makes it clear that an installation of the gap seal 60 in a filter gap 41 formed between adjacent filter elements 31 can be realized in a particularly simple fashion because no tool is required and the gap seal 60 can be securely positioned in the filter gap 41 by locking the supporting stop 63 relative to the tension element 61 under prestress by means of a pressure spring element 46.

In contrast to the exemplary embodiments shown, it is naturally also possible, if so required, to assign several prestressing devices to the sealing strips of the gap seals rather than only one prestressing device.

1. A conveyor belt filter device for mechanically cleaning a fluid that is polluted with solids and flows in a channel or the like, with
an endless filter belt of flat, interconnected filter elements that can be respectively pivoted relative to one another about a horizontal link axis and
flexible driving means that are respectively provided to both sides of the filter belt and consist, for example, of a chain drive with deflection elements and two endless drive chains, on which the filter elements are laterally mounted, as well as
a framework that carries the deflection elements and the filter belt, wherein each filter element is rigidly mounted on a chain link and front surfaces of the filter element respectively feature an abutment edge that extends parallel to the link axes of the chain links,
namely such that the opposite abutment edges define a filter gap formed between two filter elements,
characterized in
that the filter gap is provided with a gap seal that on one side of the filter belt features a sealing strip that covers the filter gap and is supported on the filter elements with the sealing force and on the other side of the filter belt features a prestressing device that is connected to the sealing strip and serves for generating the sealing force.

2. The conveyor belt filter device according to claim 1,
characterized in
that the sealing strip is arranged on the inflow side of the filter belt and the prestressing device is arranged on the outflow side of the filter belt.

3. The conveyor belt filter device according to claim 1,
characterized in
that the front surfaces of the filter elements form on the inflow side of the filter belt a wedge-shaped filter gap with gap flanks that are arranged relative to one another in an essentially V-shaped fashion and formed by the front surfaces, and in that the sealing strip adjoins the front surfaces in a sealing fashion with its longitudinal edges.

4. The conveyor belt filter device according to claim 3,
characterized in
that the longitudinal edges of the sealing strip are formed by a convexly designed peripheral contour of the sealing strip.

5. The conveyor belt filter device according to claim 1,
characterized in
that the sealing strip has a circular cross section.

6. The conveyor belt filter device according to claim 1,
characterized in
that the sealing strip has a hollow cross section.

7. The conveyor belt filter device according to claim 1,
characterized in
that the sealing strip is provided with flow-through openings for the passage of the flowing fluid.

8. The conveyor belt filter device according to claim 7,
characterized in
that the sealing strip is provided with a hole pattern such that the sealing strip acts as a filter element.

9. The conveyor belt filter device according to claim 1,
characterized in
that the sealing strip is composed of individual sealing elements that are arranged in a row.

10. The conveyor belt filter device according to claim 1,
characterized in
that the prestressing device features a tension element that is connected to the sealing strip with one end and extends through the filter gap in the flow direction, wherein the other end of said tension element is connected to a pressure spring element that is supported on a base that bridges the filter gap on the side of the filter belt that faces away from the sealing strip.

11. The conveyor belt filter device according claim 10,
characterized in
that the pressure spring consists of a dimensionally elastic plastic element.

12. The conveyor belt filter device according to claim 11,
characterized in
that the plastic element is realized in a tubular or sleeve-shaped fashion.

13. The conveyor belt filter device according to claim 1,
characterized in
that the prestressing device is arranged centrally referred to the width of the filter gap.

14. The conveyor belt filter device according to claim 2,
characterized in
that the front surfaces of the filter elements form on the inflow side of the filter belt a wedge-shaped filter gap with gap flanks that are arranged relative to one another in an essentially V-shaped fashion and formed by the front surfaces, and in that the sealing strip adjoins the front surfaces in a sealing fashion with its longitudinal edges.

15. The conveyor belt filter device according to claim 2,
characterized in
that the sealing strip has a circular cross section.

16. The conveyor belt filter device according to claim 3,
characterized in
that the sealing strip has a circular cross section.

17. The conveyor belt filter device according to claim 4,
characterized in
that the sealing strip has a circular cross section.

18. The conveyor belt filter device according to claim 2,
characterized in
that the sealing strip has a hollow cross section.

19. The conveyor belt filter device according to claim 3,
characterized in
that the sealing strip has a hollow cross section.

20. The conveyor belt filter device according to claim 5,
characterized in
that the sealing strip has a hollow cross section.
